(19) United States
(12) Patent Application Publication
(10) Pub. No.: US 2013/0243388 A1
(43) Pub. Date: Sep. 19, 2013

(54) System and Method for Controlling Video Player

(71) Applicant: O2MICRO, INC., Santa Clara, CA (US)

(72) Inventors: Sterling Shyundii Du, Shanghai (CN); Qiang Guan, Shanghai (CN); Jingjing Zuo, Beijing (CN); Chengxia He, Chengdu (CN); Qi Zhu, Chengdu (CN)

(73) Assignee: O2MICRO, INC., Santa Clara, CA (US)

(21) Appl. No.: 13/790,485

(22) Filed: Mar. 8, 2013

(30) Foreign Application Priority Data
Mar. 15, 2012 (CN) 20120068812.0

(51) Int. Cl. H04N 9/79

(52) U.S. Cl. CPC H04N 9/79
USPC 386/224

(57) ABSTRACT

A control system for a video player. The control system includes an image acquisition module, a first storage module, a comparison module and a control module. The image acquisition module is configured to scan a predetermined area in front of the video player to detect a first set of facial images when the video player is playing a tagged program. The first storage module is configured to store a second set of facial images of registered users. The comparison module is configured to compare a detected facial image in the first set of facial images with the second set of facial images. The control module is configured to control the video player based on a comparison result from the comparison module.

### RELATED APPLICATIONS

This application claims priority to Chinese Patent Application No. 201210068812.0, filed on Mar. 15, 2012 with the State Intellectual Property Office of the People's Republic of China, the specification of which is incorporated herein by reference in its entirety.

### FIELD OF THE INVENTION

The present invention relates generally to a field of video technology, specifically to a system and a method for controlling video players.

### BACKGROUND

Security and privacy are important in a person's life. For example, when people are watching a private content or sensitive content on a video player, e.g., television, computer, portable multimedia player, they may not want such content to be watched by others. Therefore, there is a need for a way for privacy control for the video player.

Furthermore, when people go out, they worry about any stranger may invade their houses and steal their possessions. Security systems are commonly installed in houses for monitoring their status. However, a conventional security system usually requires multiple monitoring devices which are too expensive for ordinary families. Therefore, there is a need for an economic solution for monitoring house security.

### SUMMARY

The embodiments described herein relate to methods and systems for controlling video players.

In an embodiment, a control system for a video player is disclosed. The control system includes an image acquisition module, a first storage module, a comparison module, and a control module. The image acquisition module is configured to scan a predetermined area in front of the video player to detect a first set of facial images when the video player is playing a tagged program. The first storage module is configured to store a second set of facial images of registered users. The comparison module is configured to compare a detected facial image in the first set of facial images with the second set of facial images. The control module is configured to control the video player based on a comparison result from the comparison module.

In another embodiment, a method for controlling a video player is disclosed. The method includes detecting a first set of first facial images by an image acquisition module when the video player is playing a tagged program, storing a second set of facial images of registered users, comparing a detected facial image in the first set of facial images with the second set of facial images by a comparison module, and controlling the video player by a control module based on a comparison result from the comparison module.

In yet another embodiment, a monitoring system of a video player is disclosed. The monitoring system includes an image acquisition module, a second storage module, a comparison module, and a processing module. The image acquisition module is configured to scan a predetermined area before the video player to detect a first set of facial images. The second storage module is configured to store a second set of facial images of registered users. The comparison module is configured to compare a detected facial image in the first set of facial images of with the second set of facial images to identify whether a user is a registered user. The processing module is configured to provide a warning if the comparison module identifies that the user is not a registered user.

In yet another embodiment, a method for house security monitoring by a video playing system is disclosed. The method includes detecting a first set of facial images by an image acquisition module, storing a second set of facial images of registered users, comparing a detected facial image in the first set of facial images with the second set of facial images to identify whether a user is a registered user by a comparison module, and providing a warning by a processing module if the comparison module identifies that the user is not a registered user.

Additional advantages and novel features will be set forth in part in the description which follows, and in part will become apparent to those skilled in the art upon examination of the following and the accompanying drawings or may be learned by production or operation of the disclosed embodiments. The advantages of the present embodiments may be realized and attained by practice or use of various aspects of the methodologies, instrumentalities and combinations set forth in the detailed description set forth below.

### BRIEF DESCRIPTION OF THE DRAWINGS

Features and advantages of embodiments of the claimed subject matter will become apparent as the following detailed description proceeds, and upon reference to the drawings, wherein like numerals depict like parts. These exemplary embodiments are described in detail with reference to the drawings. These embodiments are non-limiting exemplary embodiments, in which like reference numerals represent similar structures throughout the several views of the drawings.

FIG. 1 illustrates a block diagram of a control system for a video player, in accordance with an embodiment of the present teaching;

FIG. 2 illustrates a block diagram of a comparison module in FIG. 1, in accordance with an embodiment of the present teaching;

FIG. 3 illustrates a block diagram of a control module in FIG. 1, in accordance with an embodiment of the present teaching;

FIG. 4 illustrates a block diagram of a video playing system, in accordance with an embodiment of the present teaching;

FIG. 5 illustrates a flowchart of a method for controlling a video player, in accordance with an embodiment of the present teaching;

FIG. 6 illustrates a block diagram of a monitoring system of a video player, in accordance with another embodiment of the present teaching;

FIG. 7 illustrates a block diagram of a video playing system, in accordance with another embodiment of the present teaching; and

FIG. 8 illustrates a flowchart of a method for monitoring house security by a video playing system, in accordance with an embodiment of the present teaching.

### DETAILED DESCRIPTION

Reference will now be made in detail to the embodiments of the present teaching. While the present teaching will be described in conjunction with these embodiments, it will be understood that they are not intended to limit the present teaching to these embodiments. On the contrary, the present teaching is intended to cover alternatives, modifications and equivalents, which may be included within the spirit and scope of the present teaching as defined by the appended claims.

Furthermore, in the following detailed description of the present teaching, numerous specific details are set forth in order to provide a thorough understanding of the present teaching. However, it will be recognized by one of ordinary skill in the art that the present teaching may be practiced without these specific details. In other instances, well known methods, procedures, components, and circuits have not been described in detail as not to unnecessarily obscure aspects of the present teaching.

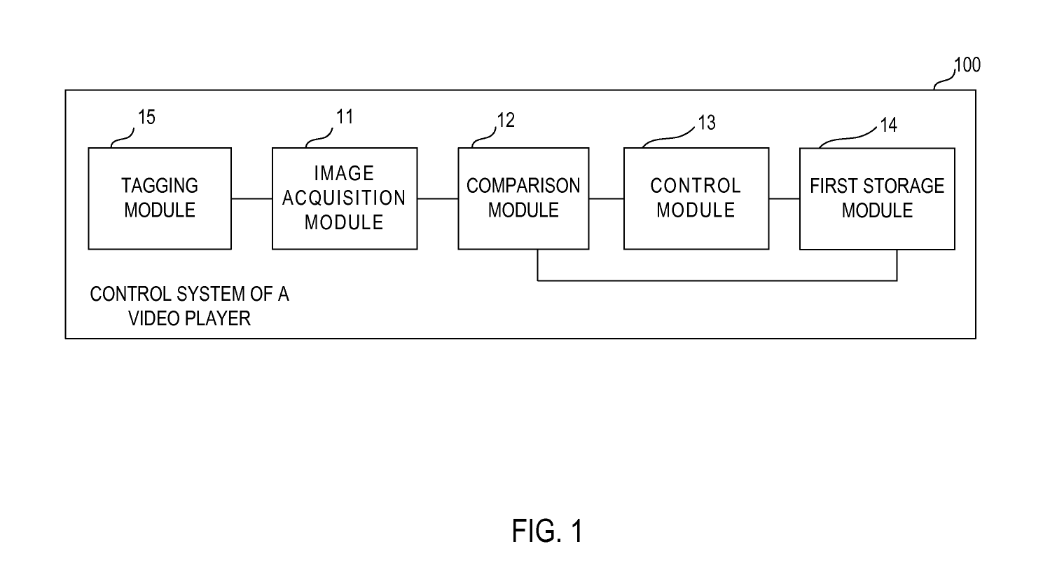

The present invention enables a video player to automatically determine the identity of users sitting in front of the video player and then play programs according to the priority level assigned to the user. The video player scans the facial images of the users and then compares the scanned facial images with stored facial images to identify whether the users have permission to watch the playing program. FIG. 1 illustrates a block diagram of a control system 100 for a video player, in accordance with an embodiment of the present teaching. As shown in FIG. 1, the control system 100 includes an image acquisition module 11, a comparison module 12, a control module 13, a first storage module 14 and a tagging module 15.

The first storage module 14 is configured to store information about registered users. The tagging module 15 is configured to tag programs on a program list in the video player. More specifically, the information of the registered users includes a second set of facial images and priority levels of users. Each registered user is assigned a priority level. The priority level is used to determine which user has the permission to watch tagged programs. Take a family with parents and children for example, parents may be assigned the highest priority level, e.g., a first priority level. Children may be assigned a lower priority level, e.g., a second priority level. Only users with the first priority level have the permission to watch the tagged programs. The tagged programs may be programs that contain private contents that the users with the highest priority level do not want to share with others. Tags can be made prior or during the time the programs are watched. Moreover, friends of the family may be assigned different priority levels depending on the relationship with the family member. A user is identified as a non-registered user if there is no information about the user stored in the first storage module 14.

The image acquisition module 11 is configured to detect a first set of facial images of users sitting in front of the video player. When the video player is playing tagged programs, the image acquisition module 11 scans a predetermined area in front of the video player to detect the first set of facial images of users and transmits the first set of facial images to the comparison module 12. The comparison module 12 is configured to compare a detected facial image in the first set of facial images with the second set of facial images stored in the first storage module 14. The comparison module 12 can compare one detected facial image with one facial image or multiple facial images in the first storage module 14 to identify the user and transmit a comparison result to the control module 13. The control module 13 is configured to control the video player to play programs based on the comparison result.

Moreover, the image acquisition module 11 may include a motion sensor for detecting motions of users in front of the video player. If the motion sensor detects motions of a user, the image acquisition module 11 begins to detect the facial image of the user. Otherwise, if the motion sensor does not detect any motion of users, the image acquisition module stops scanning to save energy.

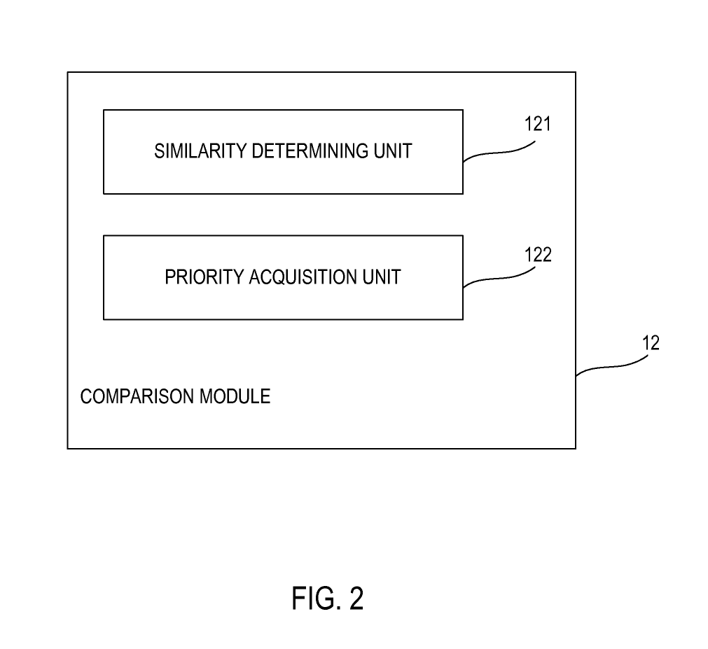

FIG. 2 illustrates a block diagram of a comparison module 12 in FIG. 1, in accordance with an embodiment of the present teaching. As shown in FIG. 2, the comparison module 12 includes a similarity determining unit 121 and a priority acquisition unit 122.

The similarity determining unit 121 is configured to compare the detected facial image in the first set of facial images with the second set of facial images in the first storage module 14 to determine a similarity level of the user. If the similarity level is lower than a predetermined threshold, the similarity determining unit 121 determines the user is a non-registered user and transmits the comparison result to the control module 13. The control module 13 controls the video player based on the comparison result. If the similarity level of the user is higher than the predetermined threshold, the similarity determining unit 121 determines the user as a registered user and transmits the comparison result to the priority acquisition unit 122, and the priority acquisition unit 122 acquires a priority level of the user from the first storage module 14 and transmits the priority level to the control module 13.

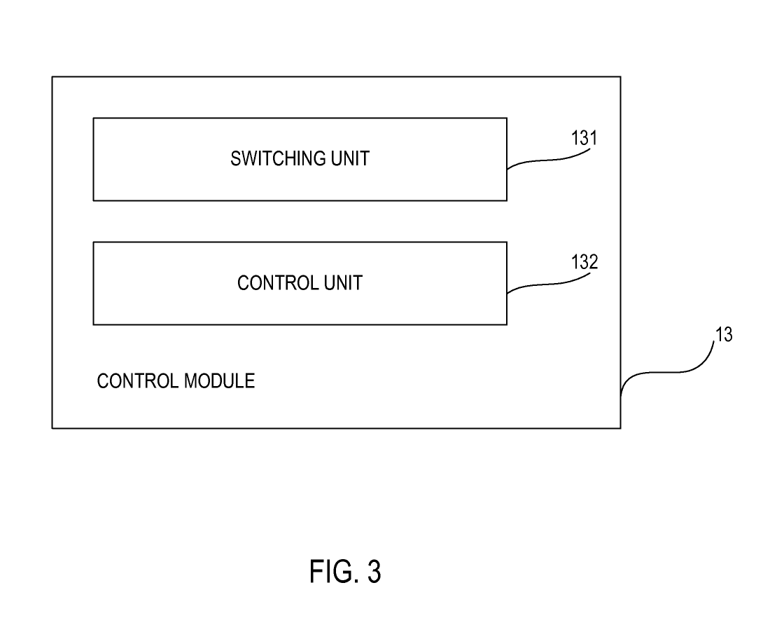

FIG. 3 illustrates a block diagram of a control module 13 in FIG. 1, in accordance with an embodiment of the present teaching. As shown in FIG. 3, the control module 13 includes a switching unit 131 and a control unit 132.

The switching unit 131 is configured to disable the playing of tagged programs if the user is a non-registered user or if the user is a registered user but the priority level of the user is lower than the first priority level.

The control unit 132 is configured to control the image acquisition module 11 to continue detecting facial images in the predetermined area in front of the video player if the user is a registered user and the priority level of the user is first priority level. More specifically, if the user is a registered user and the priority level of the user is first priority level, the control unit 132 enables the motion sensor in the image acquisition module 11 to detects motions of users in front of the video player for a new round identification. If the motion sensor detects motions of a user, the image acquisition module 11 begins to detect the facial image of the user.

More specifically, during the time the tagged programs are watched, if the control module 13 receives a comparison result indicating that the user is a non-registered user from the similarity determining unit 121 or a comparison result indicating that the priority level of the user is lower than the first priority level from the priority acquisition unit 122, the switching unit 131 switches the contents displayed on the screen of the video player from the tagged program to an untagged program or replaces the display of the video player to a screen saver with a warning message, and the control module 13 controls the image acquisition module 11 to stop scanning.

If the control module 13 receives a comparison result indicating that the user is a registered user and the priority level of the user is at the first priority level, the switching unit does not switch the current playing program and the control unit 132 controls the image acquisition module 11 to continue scanning to check whether the users sitting in front of the video player have changed. If the users have changed either by adding a new user who is non-registered or by replacing an existed user, the control unit 132 controls the image acquisition module 11 to detect facial images of users.

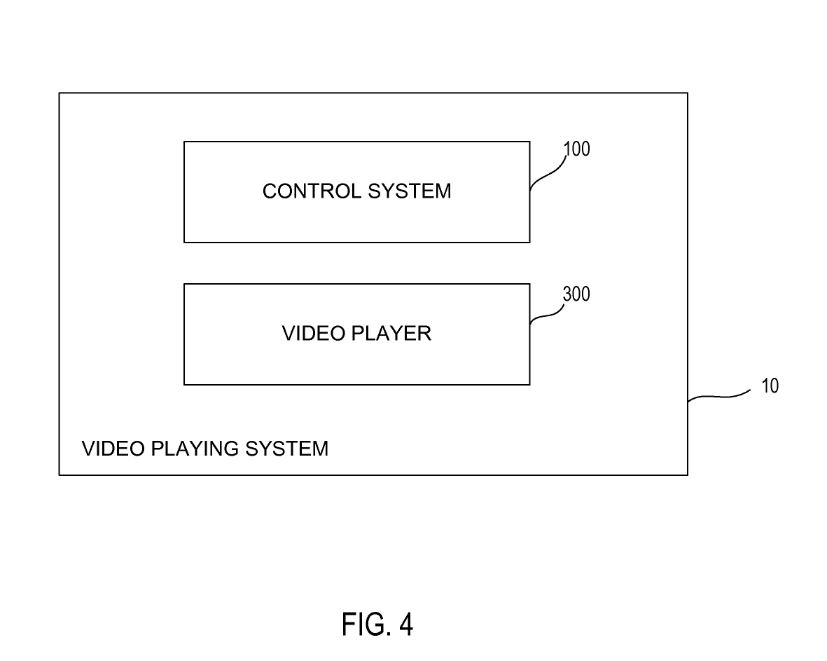

FIG. 4 illustrates a block diagram of a video playing system 10, in accordance with an embodiment of the present teaching. The video playing system 10 includes the control system 100 described in FIG. 1 and a video player 300.

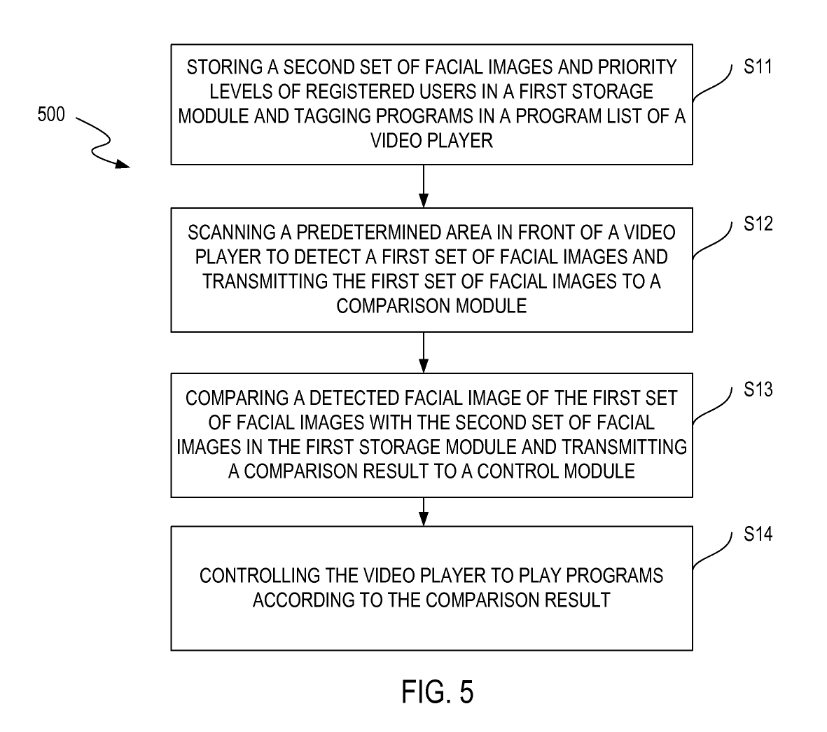

FIG. 5 illustrates a flowchart 500 of a method for controlling a video player, in accordance with an embodiment of the present teaching. FIG. 5 is described in combination with FIG. 1.

A first storage module 14 stores information about the registered users, and a tagging module 15 tags programs in a program list of the video player, step S11. The information includes a second set of facial images and priority levels of users. The tagged programs can be programs that contain private contents. Tags can be made prior to or during the time the programs are watched by the users. The tags for each program can be changed by a user but only by the user who has the highest priority level. Alternatively, the tag for each program can be changed by a user who has the permission to watch that particular program, i.e., the user does not have the permission to change the tag of a tagged program that he has no permission to watch. For example, a user with a lower priority level can watch an untagged program and can make tags on an untagged program. After tagging the program, the program requires the highest priority level to watch. The user with the lower priority level will not be able to watch that program and can no longer change the tag for that program.

When the video player is playing a tagged program, an image acquisition module 11 scans a predetermined area in front of the video player to detect a first set of facial images and transmits the first set of facial images to a comparison module 12, step S12. The comparison module 12 compares a detected facial image in the first set of facial images with the second set of facial images and transmits a comparison result to a control module 13, step S13.

More specifically, a similarity determining unit 121 in the comparison module 12 compares the detected facial image in the first set of facial images with the second set of facial images to determine a similarity level of a user.

If the similarity level of the user is higher than a predetermined threshold, the similarity determining unit 121 transmits the comparison result to a priority acquisition unit 122 in the comparison module 12. The priority acquisition unit 122 acquires a priority level of the user if the similarity level of the user is higher than the predetermined threshold from the first storage module 14 and transmits the priority level to the control module 13. If the similarity level of the user is lower than the predetermined threshold, the similarity determining unit 121 transmits the comparison result to the control module 13.

The control module 13 controls the video player to play programs according to the comparison result, step S14. More specifically, a user is determined to be a registered user by the comparison module 12 if the similarity level of the user is higher than the predetermined threshold. Otherwise, a user is determined to be a non-registered user by the comparison module 12 if the similarity level of the user is lower than the predetermined threshold. If a user is a non-registered user or if a priority level of a registered user is lower than the first priority level, the switching unit 131 switches the contents displayed on the screen of the video player from the tagged program to a screen saver or to an untagged program if the video player is playing a tagged program.

If a user is a registered user and the priority level of the user is at the first priority level, the control module 13 controls the image acquisition module 11 to continue scanning without interrupting the current playing program.

Accordingly, the present invention provides a control system for a video player and a method for controlling a video player. The control system scans a predetermined area in front of the video player to detect facial images of the users. The control system compares the detected facial images with stored facial images to identify whether a user has the permission to watch tagged programs. Advantageously, the control system protects the privacy of users by switching the contents displayed on the screen of the video player from the tagged program to a screen saver or to an untagged program if a user without the permission to watch tagged programs is present in the predetermined area in front of the video player.

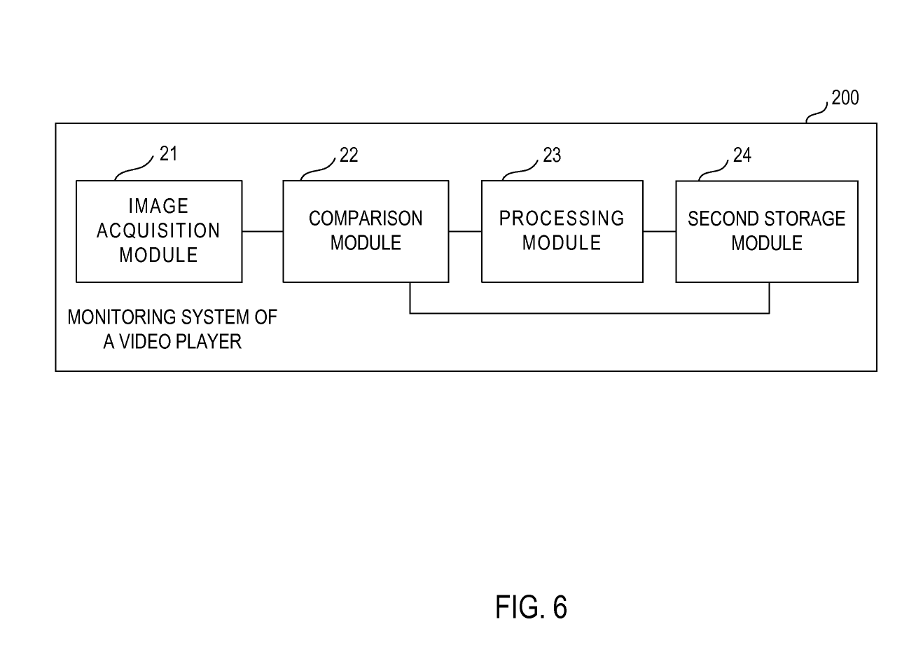

FIG. 6 illustrates a block diagram of a monitoring system 200 of a video player, in accordance with an embodiment of the present teaching. The monitoring system 200 includes an image acquisition module 21, a comparison module 22, a processing module 23 and a second storage module 24.

The second storage module 24 is configured to store information of registered users. The information includes a second set of facial images and contact information (e.g., phone numbers) of registered users.

The image acquisition module 21 is configured to scan a predetermined area in front of the video player to detect a first set of facial images and transmit the first set of facial images to the comparison module 22. The image acquisition module 21 scans in a predetermined time period or at a predetermined time interval.

The comparison module 22 is configured to compare a detected facial image in the first set of facial images with the second set of facial images in the second storage module 24 to identify whether a user is a registered user and transmit a comparison result to the processing module 23. The processing module 23 is configured to determine whether to give a warning based on the comparison result from the comparison module 22.

More specifically, if the comparison module 22 identifies the user as a registered user, the processing module 23 controls the image acquisition module 21 to continue scanning to detect the first set of facial images. If the comparison module 22 identifies the user as a non-registered user, the processing module 23 controls the video player to display a warning signal. The warning signal includes the detected facial image of the non-registered user and a warning sound. Registered users may include family members and friends of the family. Moreover, the processing module 23 transmits the warning signal to an intelligent terminal of one family member if there is no family member in the predetermined area in front of the video player. Alternatively, the processing module 23 may also transmit the warning signal to a remote monitoring center who may notify a law enforcement agency about possible house break-in. The intelligent terminal includes, but not limit to, cell phone and Ipad™.

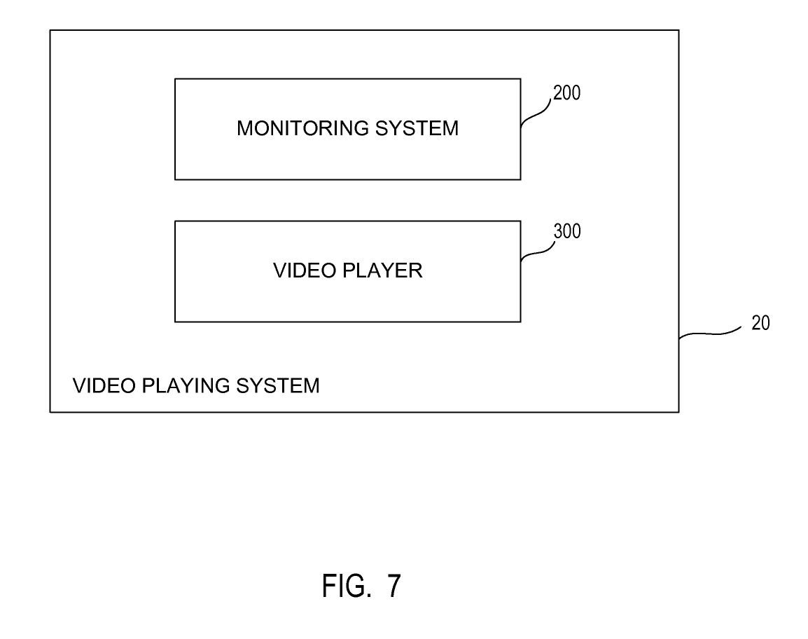

FIG. 7 illustrates a block diagram of a video playing system 20, in accordance with another embodiment of the present teaching. The video playing system 20 includes a monitoring system 200 described in FIG. 6 and a video player 300.

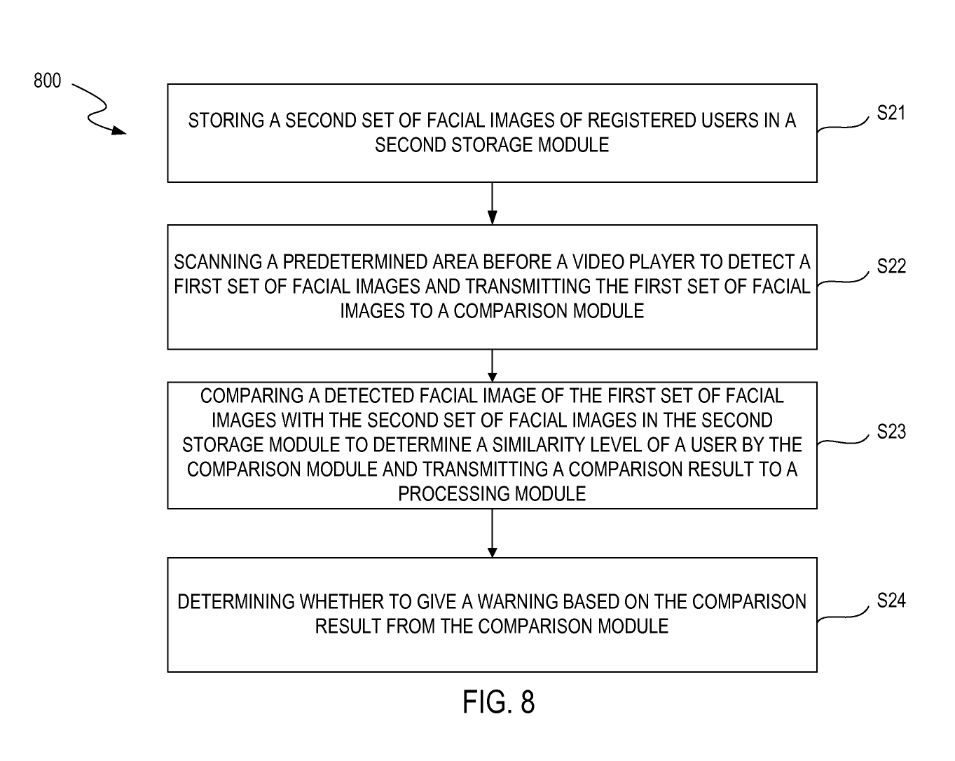

FIG. 8 illustrates a flowchart 800 of a method for house security monitoring using a video playing system, in accordance with an embodiment of the present teaching. FIG. 8 is described in combination with FIG. 6.

A second storage module 24 stores information of registered users, step S21. As an example, registered users can include family members and friends. The information includes a second set of facial images and contact information (e.g., phone numbers) of registered users.

An image acquisition module 21 scans a predetermined area in front of the video playing system to detect a first set of facial images and transmits the first set of facial images to a comparison module 22, step S22.

The comparison module 22 compares a detected facial image in the first set of facial images with the second set of facial images in the second storage module 24 to identify whether a user is a registered user and transmits a comparison result to a processing module 23, step S23.

More specifically, the comparison module 22 compares the detected facial image in the first set of facial images with the second set of facial images to determine a similarity level of the user. If the similarity level of the user is higher than a predetermined threshold, the user is determined by the comparison module 22 as a registered user. If the similarity level of the user is lower than the predetermined threshold, the user is determined by the comparison module 22 as a non-registered user, e.g., a stranger or a trespasser.

The processing module 23 determines whether to give a warning based on the comparison result from the comparison module 22, step S24. More specifically, if the comparison module 22 identifies the user as a registered user, the processing module 23 controls the image acquisition module 21 to continue scanning. If the comparison module 22 identifies the user as a non-registered user, the processing module 23 controls the video player to display a warning signal immediately. The warning signal includes the detected facial image of the user and a warning sound. As an example, the registered users can include family members and friends of the family. Moreover, the processing module 23 transmits the warning signal to an intelligent terminal of one family member if there is no family member in the house. The intelligent terminal includes, but not is limited to, cell phone and Ipad™.

Accordingly, the present invention provides a monitoring system of a video player and method for house security monitoring. The monitoring system scans a predetermined area in the house to detect facial images of the users. Then the monitoring system compares the detected facial images with stored facial images to identify whether the user is a stranger. The monitoring system controls the video player to display warning signal immediately if a stranger is present in the predetermined area before the video player. Thus the monitoring system can monitor house status real-timely. Advantageously, the monitoring system of a video player is economical and convenient solution for house security monitoring without the need for installing multiple monitoring devices.

Those skilled in the art will recognize that the embodiments of the present teaching are amenable to a variety of modifications and/or enhancements. For example, although the implementation of various components described above may be embodied in a hardware device, it can also be implemented as a software only solution—e.g., an installation on an existing server. In addition, the dynamic relation/event detector and its components as disclosed herein can be implemented as firmware, a firmware/software combination, a firmware/hardware combination, or a hardware/firmware/software combination.

While the foregoing description and drawings represent embodiments of the present teaching, it will be understood that various additions, modifications and substitutions may be made therein without departing from the spirit and scope of the principles of the present teaching as defined in the accompanying claims. One skilled in the art will appreciate that the teaching may be used with many modifications of form, structure, arrangement, proportions, materials, elements, and components and otherwise, used in the practice of the teaching, which are particularly adapted to specific environments and operative requirements without departing from the principles of the present teaching. The presently disclosed embodiments are therefore to be considered in all respects as illustrative and not restrictive, the scope of the teaching being indicated by the appended claims and their legal equivalents, and not limited to the foregoing description.

We claim:

1. A control system for a video player, the control system comprising:
an image acquisition module for scanning a predetermined area in front of the video player to detect a first set of facial images when the video player is playing a tagged program;
a first storage module for storing a second set of facial images of registered users;
a comparison module for comparing a detected facial image in the first set of facial images with the second set of facial images; and
a control module for controlling the video player based on a comparison result from the comparison module.

2. The control system of claim 1, wherein the comparison module comprises:
a similarity determining unit for comparing the detected facial image with the second set of facial images to determine a similarity level of a user; and
a priority acquisition unit for acquiring a priority level of the user and, if the similarity level of the user is higher than a predetermined threshold, for transmitting the priority level of the user to the control module,
wherein the similarity determining unit transmits the comparison result to the control module if the similarity level of the user is lower than the predetermined threshold, and transmits the comparison result to the priority acquisition unit if the similarity level of the user is higher than the predetermined threshold.

3. The control system of claim 2, wherein the control module further comprises:
a switching unit for switching contents displayed on a screen of the video player from the tagged program to another untagged program if the similarity level of the user is lower than the predetermined threshold or if the similarity level of the user is higher than the predetermined threshold but the priority level of the user is lower than a first priority level; and
a control unit for controlling the image acquisition module to keep scanning the predetermined area before the video player to detect the first set of facial images if the similarity level of the user is higher than the predetermined threshold and the priority level of the user is at the first priority level.

4. The control system of claim 1, wherein the first storage module further stores priority levels of the registered users.

5. The control system of claim 1, wherein the control system further comprises:
a tagging module for tagging programs in a program list of the video player as tagged programs.

6. A method for controlling a video player, comprising the steps of:
detecting a first set of first facial images by an image acquisition module when the video player is playing a tagged program;
storing a second set of facial images of registered users by a first storage module;
comparing a detected facial image in the first set of facial images with the second set of facial images by a comparison module; and
controlling the video player by a control module based on a comparison result from the comparison module.

7. The method of claim 6, further comprising the step of:
scanning a predetermined area in front of the video player by the image acquisition module.

8. The method claim 6, further comprising the step of:
storing priority levels of the registered users by the first storage module.

9. The method of claim 6, further comprising the step of:
tagging programs on a program list of the video player as tagged programs.

10. The method of claim 6, wherein the step of comparing a detected facial image in the first set of facial images with the second set of facial images by a comparison module further comprises the steps of:
comparing the detected facial image in the first set of facial images with the second set of facial images to determine a similarity level of a user by a similarity determining unit;
acquiring a priority level of the user by a priority acquisition unit if the similarity level of the user is higher than a predetermined threshold; and
transmitting the priority level of the user to the control module by the priority acquisition unit.

11. The method claim 10, wherein the step of controlling the video player by a control module based on a comparison result from the comparison module further comprises the steps of:
switching contents displayed on a screen of the video player from the tagged program to another untagged program if the similarity level of the user is lower than a predetermined threshold or if the similarity level of the user is higher than the predetermined threshold but the priority level of the user is lower than a first priority level; and
controlling the image acquisition module to keep detecting the first set of facial images before the video player if the similarity level of the user is higher than the predetermined threshold and the priority level of the user is at the first priority level.

12. A monitoring system of a video player, the monitoring system comprising:
an image acquisition module for scanning a predetermined area in front of the video player to detect a first set of facial images;
a second storage module for storing a second set of facial images of registered users;
a comparison module for comparing a detected facial image in the first set of facial images with the second set of facial images to identify whether a user is a registered user; and
a processing module for providing a warning if the comparison module identifies that the user is not a registered user.

13. The monitoring system of claim 12, wherein the comparison module is configured to:
compare the detected facial image in the first set of facial images with the second set of facial images to determine a similarity level of the user; and
transmit a comparison result to the processing module.

14. The monitoring system of claim 12, wherein the processing module is configured to:
control the video player to display a warning signal; and
transmit the warning signal to an intelligent terminal of one of the registered users if the comparison module identifies that the user is not a registered user based on the comparison result.

15. The monitoring system of claim 14, wherein the warning signal comprises a facial image of the user detected by the image acquisition module and a warning sound.

16. The monitoring system of claim 14, wherein the second storage module further stores contact information of the registered users.

17. A method for house security monitoring using a video playing system, comprising the steps of:
detecting a first set of facial images by an image acquisition module;
storing a second set of facial images of registered users by a second storage module;
comparing a detected facial image in the first set of facial images with the second set of facial images to identify whether a user is a registered user by a comparison module; and
providing a warning by a processing module if the comparison module identifies that the user is not a registered user.

18. The method of claim 17, further comprising the step of:
scanning a predetermined area in front of the video playing system by the image acquisition module.

19. The method of claim 17, wherein the step of comparing a detected facial image in the first set of facial images with the second set of facial images to identify whether a user is a registered user by a comparison module further comprises the step of:
comparing the detected facial image in the first set of facial images with the second set of facial images to determine a similarity level of the user.

20. The method of claim 17, wherein the step of providing a warning by a processing module if the comparison module identifies that the user is not a registered user further comprises the steps of:
controlling the video playing system to display a warning signal; and
transmitting the warning signal to an intelligent terminal of one of the registered users if the comparison module identifies that the user is not a registered user.

21. The method of claim 20, wherein the warning signal comprises a facial image of the user detected by the image acquisition module and a warning sound.

22. The method of claim 20, further comprising the step of:
storing contact information of the registered users by the second storage module.
